(19) United States
(12) Patent Application Publication
(10) Pub. No.: US 2013/0125434 A1
(43) Pub. Date: May 23, 2013

(54) Display Apparatus For A Vehicle

(71) Applicant: Raymond Cozens, Stevenage (GB)

(72) Inventor: Raymond Cozens, Stevenage (GB)

(73) Assignee: CBT Developments Limited, Stevenage, Herffordshire (GB)

(21) Appl. No.: 13/698,640

(22) PCT Filed: May 17, 2011
(86) PCT No.: PCT/GB11/50939

§ 371 Date: Jan. 30, 2013

(30) Foreign Application Priority Data
May 18, 2010 (GB) 1008275.8

(51) Int. Cl. G09F 7/12; G09F 17/00; G09F 21/04; G09F 7/18

(52) U.S. Cl. CPC G09F 7/12; G09F 7/18; G09F 17/00; G09F 21/04
USPC 40/593

(57) ABSTRACT

A display apparatus for a vehicle including a vent portion (1) comprising a through-opening defining an air intake mouth, and attachment means adapted to render the vent portion attachable therewith to a surface of the vehicle in a position intimately proximate thereto to permit the air-intake mouth to intake vehicle-displaced airflow at the aforesaid surface of the vehicle. A flexible sleeve portion (35) defines an air duct extending from the through-opening to an air outlet opening of the sleeve portion being inflatable by action of a flow of air therethrough from the through-opening to display an outer surface of the inflated sleeve portion.

The invention relates to apparatus and methods for displays. In particular, though not exclusively, the invention relates to displays for/from vehicles.

Conventional flags may be attached to vehicles to display images, signs, information or the like. They tend to be extremely dynamic in appearance when the vehicle to which they are attached is moving, to the extent that the image being displayed maybe difficult to interpret by road users and pedestrians alike. Furthermore, this excessive dynamism can be seriously distracting to many road users; and potentially dangerous in that it may startle horses using the highway.

For celebratory reasons people often display neck scarves from a moving vehicle by trapping a small part of its length in a window or door and allowing the majority of it's length to be displayed on the exterior of the vehicle. As with conventional flags, due to the extreme dynamism experienced by the free end of the scarf while the vehicle is in motion the message often fails to be communicated, either because it is moving around too quickly, or because the free end has become twisted in a corkscrew manner.

The invention aims to provide means and methods of display from a moving vehicle which may be an improvement on existing techniques.

At its most general the invention proposed is the advantageous utilisation of airflow over and around a vehicle, particularly while in motion, to generate a display surface for displaying an image, marking or sign in a physically and visually stable three dimensional manner at the surface (e.g. exterior) of the vehicle. The image may thus be readily discernable by road users and pedestrians alike. The display surface may be provided by virtue of an inflatable sleeve arrangement from the surface of which an image, sign or marking may be presented when inflated by the airflow over and around a vehicle.

For example, in a first of its aspects, the invention may provide a display apparatus for a vehicle including: a vent portion comprising a through-opening defining an air intake mouth, and attachment means adapted to render the vent portion attachable therewith to a surface of the vehicle in a position (e.g. secure, e.g. fixed position) intimately proximate thereto to permit the air-intake mouth to intake vehicle-displaced airflow at the aforesaid surface of the vehicle; a flexible sleeve portion defining an air duct extending from the through-opening to an air outlet opening of the sleeve portion being inflatable by action of a flow of air therethrough from the through-opening to display an outer surface of the inflated sleeve portion.

In this way, the vent may be mounted, positioned or secured closely to a local surface part of a vehicle over which air is displaced to flow when the vehicle is in motion. It has been found that this displaced air flow is generally of a higher relative velocity than is that of more distant ambient air further from a moving vehicle (i.e. higher than the vehicle speed). This is believed to be analogous to an aero-foil whereby a mass of air split/separated by the moving aero-foil moves more quickly over the parts of the aero-foil shaped to enforce the most lateral air displacement. The flow of displaced air is generally streamlined flow which tends to be stable and which tends to follow, hug or replicate the shape of the vehicle surface over which it flows. Accordingly, by capturing this high-speed, stable and vehicle-hugging air-flow, the vent portion permits the sleeve portion to be inflated in a way which stably follows the local shape of the vehicle surface, is far less prone to flap (streamlined air flow) undesirably, and at lower vehicle speeds than would otherwise be the case. Preferably, the vent portion and/or attachment means are adapted to attach the vent portion on to a surface area of a vehicle such that the vent portion covers that surface area. Preferably the direction of airflow which the air-intake mouth is arranged to receive is generally or substantially parallel to the aforementioned surface area of the vehicle. The parts of the vent portion adapted to be nearmost the aforesaid surface area in use (e.g. nearest the attachment means) are preferably substantially flat, or substantially coplanar or substantially conform to a common collective profile shape which is adapted to intimately oppose an aforesaid vehicle surface area in use. For example, preferably the display apparatus is adapted to be attached to a vehicle surface area equal to or greater in size than the coverage or foot-print of the vent portion or attachment means. For example the attachment means may be adapted (e.g. shaped and/or sized) to attach to a vehicle body part or panel. Examples include a vehicle window outer surface, or vehicle door outer surface, or vehicle bonnet (hood) outer surface, or vehicle boot (trunk) outer surface.

Preferably, the attachment means is not located in or at the air intake mouth. Accordingly, the attachment means is preferably adapted to attach to a vehicle such that parts of the attachment means do not pass into, across or through the air-intake mouth in such a way which would obstruct the air-intake mouth. The attachment means may be arranged to attach onto an extended surface area of a vehicle over which airflow is generally parallel when the vehicle is in motion.

The vent portion may be detachably attachable to the exterior surface of a host vehicle. The position of the vent portion when so attached is preferably with the air intake mouth oriented generally in the forward (vehicular) direction. The air intake mouth may be adapted to be rotatingly mounted (e.g. as in a turret or about an axle) to a vehicle. For example, the air intake mouth may be rotatingly connected to the attachment means, or rotatingly mounted (e.g. as in a turret or axle) to a base portion of the vent portion which the attachment means is adapted to securely position nearmost the vehicle surface. The air intake mouth may be arranged to be rotatable about an axis or axes extending generally away from or generally across (e.g. in a direction generally inclined or parallel to, or perpendicular to) the base portion. This may permit the air intake mouth to rotate about a generally horizontal, vertical or inclined axis when attached to the vehicle and so permit the air intake mouth to adopt a stable, optimal orientation when subjected to air flow over the vehicle in motion. This may permit the vent to move to maximise air intake rates and permit a reduction of net forces upon the assembly in use transverse to the direction of air flow which may urge the vent portion to separate from the vehicle. The vent portion may be sparsely or highly featured in appearance. It may further assume the appearance of a mythical creature, animated film character or indeed, any culturally familiar image or icon.

The gape of the air intake mouth is preferably elongated. The attachment means is preferably adapted to render the vent portion attachable therewith to the surface of the vehicle in a position such that the elongated gape of the air intake mouth extends a greater distance across said local surface of the vehicle than it extends away from said local surface of the vehicle. Accordingly, the shaping of the air intake mouth is preferably adapted to capture a higher proportion of air flow occurring closer to the surface of the vehicle where it is generally of higher velocity and less prone to turbulence. The elongate shape may define a long (e.g. longest) axis transversely across the air intake mouth, in a direction from one side of the mouth to the other side. The mouth may have a shorter (or shortest) axis which extends in a direction from the bottom of the mouth to the top of the mouth. Preferably, the attachment means are arranged to position the bottom of the mouth closest to the local vehicle surface. The vent portion may include a base portion comprising a vehicle interface region being the region of the vent portion which the attachment means is adapted to position nearmost the vehicle surface. The attachment means may comprise one or more suction cups arranged to face outwardly of the surface of a base portion to attach the base portion to the vehicle by suction. The vent assembly (which maybe static or articulated, rotatable or pivotably attached to the base portion) may be fitted with one or more circular suction cups upon the surface that will ultimately mate with the host vehicle exterior surface. Preferably substantially only the cup formations of the/each suction cup projects beyond the local surface of the vent base to which they are attached or formed. Accordingly, in use the cup formations may substantially flatten when pressed against a vehicle surface in use such that the separation between the surface of the vent base portion and the local surface of the vehicle is substantially no greater (or little greater) than the insignificant height of the flattened cups.

The vent assembly is further fitted with a quantity of ‘Velcro’ hook coins that are distributed around the peripheral outward facing surface of a generally rearward facing flange.

The vent assembly may further be fitted with a badge device, which generally faces forward in operation.

The through-opening is preferably shaped to define an air flow direction therethrough. The air intake mouth may present an elongated gape in said air flow direction. For example, the air intake mouth may have a circumferential perimeter lip/rim defining its edges. The circumferential shape of the perimeter may be elongate or may be non-elongate (e.g. a circle) and disposed within the vent portion to adopt a reclining or “swept-back” orientation relative to the surface of the vehicle when attached thereto by the attachment means. The degree of inclination is preferably such that, if the shape of the intake mouth perimeter is not elongated, then the shape that it projects in the direction of air intake/flow (i.e. its forward projection) presents an elongated shape extending more across the local vehicle surface than away from it. An example is where the mouth perimeter is a flat circular shape which is inclined in use to present a forward projection which is elliptical with a major axis parallel to the local vehicle surface.

The through-opening may define an air duct extending from a perimeter lip/rim of the air intake mouth to an air outlet throat in fluid communication with the flexible sleeve. The through-opening may narrow or taper or become increasingly constricted from its air inlet end to its air-outlet end to define a ram-air intake. A ram-air intake is, for example, any air intake system which uses the air pressure created by vehicle motion to increase the air pressure inside of an air intake manifold (e.g. as defined by the vent part and the additionally by the tapered sleeve part). The area of the air outlet opening is preferably less than the area of the through-opening.

The vent portion may include a base portion comprising a vehicle interface region being the region of the vent portion which the attachment means is adapted to position nearmost the vehicle surface. The vent portion may include an air deflection surface portion shaped for deflecting air in a direction away from the vehicle interface region and into the air intake mouth. Thus, an aero-foil portion may be provided not only to sweep extra streamlined air flow into the mouth of the vent, but also to generate a reactive pressure from the swept-up air which urges the vent portion in a direction towards the local vehicle surface thereby increasing vent stability.

The vent portion may include an arch portion extending over the base portion and joined thereto at opposite arch ends thereby defining the through-opening. The arch portion may be shaped to present a surface facing away from the though-opening which is shaped for deflecting air in a direction away from the air intake mouth. This shaping may also be so as to provide an aero-foil function which not only promotes streamlines (non-turbulent) air flow over the vent and sleeve portion—enhancing sleeve stability when inflated—but also generating an urging force towards the local surface of the vehicle for added vent stability. Outward-facing surface areas of the vent may be generally convex with a common radius of curvature centered upon a common point (i.e. a locus of convex surface points which coincide with parts of the same spherical surface shape). Outermost parts of the forward-facing surface of the vent portion not forming a part of the through-opening may present a convex hemispherical surface.

The vent portion is preferably rigid or resilient or semi-rigid. The vent portion may include a highly perforated (for air flow) grille extending across the gape of the through-opening either in front or, within or behind the duct of the through-opening. Alternatively, the through-opening may be generally open and unobstructed in its construction.

The sleeve portion is preferably sufficiently flexible to be collapsible when not inflated. The sleeve portion may be formed from a fabric, web, or sheet of suitably flexible/collapsible material. Materials such as textiles, plastics or paper may be used. The sleeve portion is preferably detachably attachable to the vent portion. The sleeve portion may comprise a sheet having two short edges separated by two long edges which long edges are detachably attached together along their respective lengths to define a sleeve. The air inlet end of the sleeve portion may possess sleeve attachment means adapted to cooperate with corresponding sleeve attachment means formed on or secured to the vent portion to permit the air inlet end of the sleeve portion to be removably attached to the air outlet end of the through-opening. The outward surface of the vent portion adjacent and surrounding the air outlet end of the through-opening may be recessed or inwardly stepped relative to the preceding outward surface parts of the vent portion to provide a recess for attaching the sleeve portion to the outlet of the through-opening. The sleeve attachment means may be arrayed circumferentially along this recessed outward surface for cooperating with the air inlet end of the sleeve portion. This recessing preferably of an extent sufficient to permit all but the inner volume of the sleeve portion to be shielded from direct impact by air flow over and past the vent portion in use when the sleeve is fully inflated. This avoids parts of the sleeve portion from causing turbulence to air flow over the apparatus and means that air flow over the sleeve portion tends not to directly urge against the sleeve to deflate it.

Press-studs or Velcro® pads may be attached along the inner periphery of the air inlet end of the sleeve portion for affixing to corresponding (reciprocal) press-studs or Velcro® pads attached to the outer periphery of the air outlet end of the through-opening. Similarly, if the sleeve portion is a sheet with two shorter edges separated by opposite long edges, reciprocal press-stud parts or Velcro® pads may be arrayed adjacent along the long edges on opposite sides of the sheet such that the sheet may be formed into a tube by bringing together the opposite long edges of the sheet and fixing together reciprocal pairs of press-stud parts or Velcro® pads. The forward facing aperture of the sleeve arrangement may be fitted with a band of ‘Velcro’ loop type fabric fastening, on the inward facing surface, and this is preferably adapted to attach to corresponding Velcro hook fabric distributed around the outward facing rearward end flange on the vent portion. An indicator mark may be provided on the sleeve to align with a protruding feature on the vent to achieve a precise fit of sleeve to vent. The sleeve arrangement may further incorporate a tie string, adjacent the Velcro band, which is adapted to pass through a hole which may be formed in the vent assembly, and is tied off, should, for any reason the sleeve arrangement Velcro become detached from the vent assembly Velcro, while the vehicle is in motion.

The display apparatus may include retaining means connected to (preferably detachably so) the vent portion for securing the vent and sleeve portions to the vehicle in addition to (and separate from) the attachment means of the vent part. The retaining means may have a securing part adapted for secure attachment to (e.g. a surface of) the vehicle, and a flexible connection means connecting (preferably removably so) the securing part to the vent portion in the manner of a lanyard. The lanyard may be of adjustable length. It may be detachably attachable to the vent portion. The flexible connection means may be adapted and arranged to pass from the exterior to the interior of the host vehicle. The connection means may comprise a line, cable, strap, web, string or other elongate length of flexible material having opposite terminal ends which are detachably attached to the vent portion and the securing part respectively. Preferably, the securing part is adapted to detachably attach to the vehicle interior. Preferably, the connection means (lanyard) is dimensioned to pass from the exterior of the vehicle to its interior—e.g. between a closed vehicle door and the edge of the doorway, or the edge of a vehicle window pane and the window aperture when substantially closed, or the edge of a closed car sun roof and the periphery of the car bodywork against which the sun roof is closed. The result is that the retaining means acts to provide an anchorage.

The lanyard is preferably arranged to attach to the vent portion by passing through openings in the vent portion (e.g. in the base portion adjacent the attachment means). The lanyard may be arranged to pass through a lanyard interface formation comprising one or more openings or eyes in the vent potion through which an end of the lanyard may thread or pass to allow a loop to be formed by the lanyard. Preferably, the lanyard forms closed loop threaded upon the vent portion via the lanyard interface formation. Alternatively, the lanyard interface formation may be a buckle-like formation in the vent portion adapted to grip the lanyard there. One or both terminal ends of the lanyard may be arranged to pass through a buckle-like formation in the securing part (e.g. at the centre thereof) arranged to grip the lanyard there to secure the securing part to the lanyard. This may securely close the loop containing the vent portion thereby to retain the vent portion to the securing part. The position of the securing part may be adjustable to any position along the free length of the lanyard. The securing part may include one or more suction cups for attaching it to a surface (e.g. inner window surface) of the vehicle by suction.

The sleeve portion may be a non-rigid, free form sleeve arrangement. The sleeve arrangement may optionally be fitted with a suction cup, for example approximate its rearward facing aperture, by virtue of a small fabric loop present in the sleeve arrangement seam. The sleeve portion may include a sleeve attachment part for detachably attaching the sleeve to surface parts of the vehicle generally rearward of the vent assembly when attached to the vehicle. The sleeve attachment part may comprise one or more suction cups attached to the sleeve for detachably attaching the sleeve to the vehicle by suction. The sleeve attachment part may comprise a length flexible line (e.g. of string, cord, webbing or other flexible line) opposite ends of which are attached to the sleeve portion and to which the suction cup is attached. The position of the suction cup along the line may be adjustable. A fixing ring may be threaded on to the flexible line and the suction cup may include a projecting lug portion wherein the diameter of the fixing ring is dimensioned simultaneously to reversibly admit both the lug of the suction cup and the part of the flexible line passing through the fixing ring both in a tight friction fit which holds the lug portion firmly against the flexible line to adjustably fix the position of the suction cup along the line.

The sleeve arrangement may further be fitted with a badge device that generally faces rearwards in operation.

It is contemplated that the invention may be sold in kit form comprising separate parts for assembly into the display apparatus. Accordingly in a second of its aspects, the invention may provide a kit of parts for a display apparatus according to the invention in its first aspect, comprising at least two separable parts in which the vent portion is a first said part and the sleeve portion is a second said part. A third part may be the retaining means. For example, in a third of its aspects, the invention may provide a method of displaying a display from a vehicle including: providing a vent portion comprising a through-opening defining an air intake mouth, and; providing a flexible sleeve portion defining an air duct extending from the through-opening to an air outlet opening of the sleeve portion; attaching the vent portion to a surface of the vehicle in a position intimately proximate thereto to permit the air-intake mouth to intake vehicle-displaced airflow at said surface of the vehicle; inflating the sleeve portion by action of a flow of air therethrough from the through-opening to display an outer surface of the inflated sleeve portion

In this method, the gape of the air intake mouth is preferably elongated. The method may include attaching the vent portion to the surface of the vehicle in a position such that the elongated gape of the air intake mouth extends a greater distance across said surface of the vehicle than it extends away from said surface of the vehicle.

Once the vent portion and sleeve arrangement combined have been secured in the desired position on an exterior surface of the host vehicle, a lanyard cord or webbing may be passed between either the window glass or between one of the doors, from exterior to interior, thus becoming trapped when either the window or door is closed. The lanyard may then be adjusted such that a retainer assemblage at an distal end of the lanyard may be secured in position on an interior glass surface.

A sleeve-mounted suction cup may be secured about the host vehicle exterior to position the sleeve.

In use, acceleration of the host vehicle increasingly forces air through the vent assembly and inflates the sleeve assembly while the vehicle is in motion at sufficient speed, thereby displaying, in a way that is evident, the intended message or image in a dynamic yet stable manner.

The extent of temporary inflation of the sleeve assembly is primarily dependent upon the host vehicle achieving the optimal speed for the unified vent and sleeve combination.

In operation, the vent assembly may fulfil a number of functions simultaneously. It may physically integrate the product with the host vehicle. It may provide a direct interface with the host vehicle from which to mount the sleeve arrangement, assisting stabilisation (e.g. does not involve extended rods projecting from the vehicle) It may maintain the mouth of the sleeve in an open orientation. It may direct airflow into the inside of the sleeve and away from the outside of the sleeve, assisting stabilisation.

In operation, the sleeve arrangement may fulfil several functions. It may display an image, sign, design or message to be communicated, in a stable and easily-read manner. It may additionally do so in a rearward direction.

At rest, the sleeve may be arranged in one of two ways; the sleeve may either hang at a near vertical orientation, or it may be suspended in a near horizontal orientation.

In operation, the retaining assemblage may serve two functions. It may ensure that the vent assembly cannot fall to the ground, should, for any reason, it become detached from the host vehicle while in motion. It may act as an internal hook, or anchor should the owner wish to secure the product from inside the host vehicle when the vehicle is left unattended (i.e. an anti-theft device).

In a further aspect, the invention may provide attachment apparatus for detachably attaching an object to a structure comprising: a body portion including suction parts presented outwardly of the body portion and adapted and arranged to detachably attach the body part to a surface of the object by suction; a connector portion for connecting the body portion to the structure. The attachment apparatus may be adapted to attach an object, such as a mobile phone, to a vehicle (e.g. car interior fitting, bike handle bars, pram handle etc).

The suction parts may comprise one or more suction cups. The suction cups may comprise resilient hollowed and open-ended cup portions deformable by pressing the open end against a suitably flat surface of the object to expel air from the space enclosed by the cup hollow and the opposing surface of the object to which the cup is to be pressed in use. The flat and polished surfaces of electronic devices (e.g. their screens) have been found to be particularly suitable for interfacing with suction cups in this way. The attachment means may be a mobile phone attachment means. The connector portion may comprise one or more flexible tie parts extending from the body portion and adapted to tie the body portion to the structure. The one or more tie parts may comprise one or more straps, cords, or other flexible lines. The Body part may comprise one or more buckle formations through which a connector portion is threaded. For example, one or more flexible tie parts may be threaded through respective (or a common) buckle formation with one or more free tie ends positioned to tie to or around the structure (e.g. bike handle bars, car interior structure etc). Tie parts may present free tie end portions arranged to be releasibly connectable to the body portion or to another free end of a tie part thereby to encircle, embrace, enclose or tie-around the structure in question (e.g. bike handle bar, car interior structure etc) in a closed-loop arrangement including the body portion. The tie parts may comprise at or adjacent their free ends Velcro® pads, press-studs or other connection means for engaging with corresponding reciprocal connection means either on the body portion or on/adjacent another end of a tie part. The tie parts may operate in the manner of a watch strap, either with a buckle at one tie end through which another tie end is adapted to thread. The connector portion may comprise a stretchable or elasticated band.

Non-limiting examples of the invention shall now be described with reference to the accompanying drawings of which:

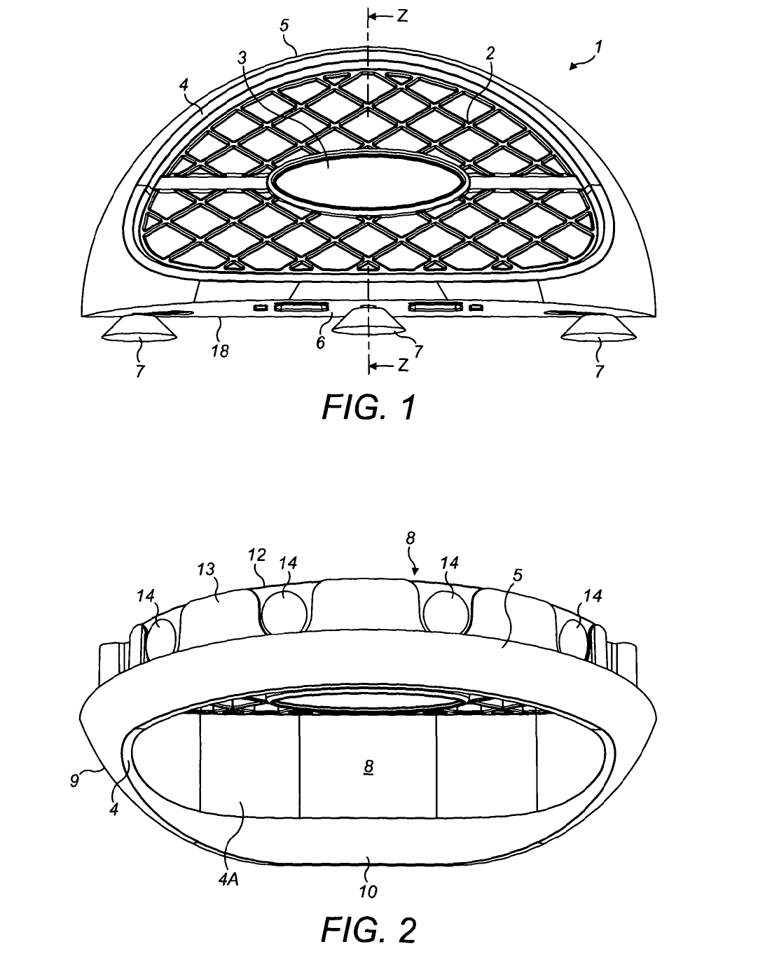

FIG. 1 illustrates a front view of a vent assembly of a display device;

FIG. 2 illustrates a top view of the vent assembly of FIG. 1;

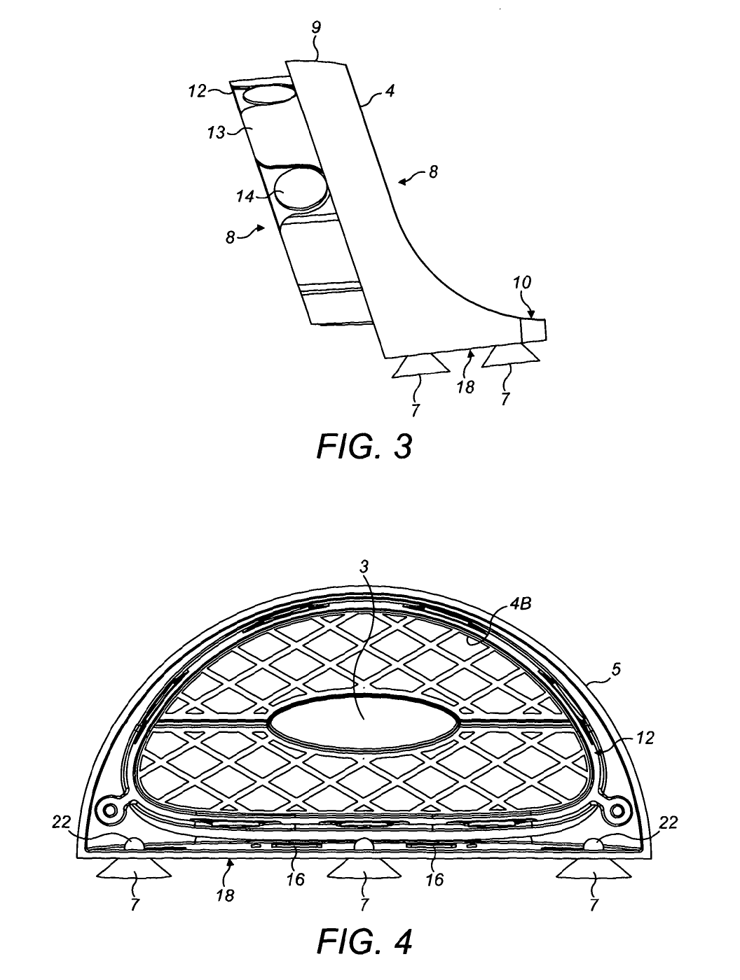

FIG. 3 illustrates a side view of the vent assembly of FIGS. 1 and 2;

FIG. 4 illustrates a back view of the vent assembly of FIGS. 1 to 3;

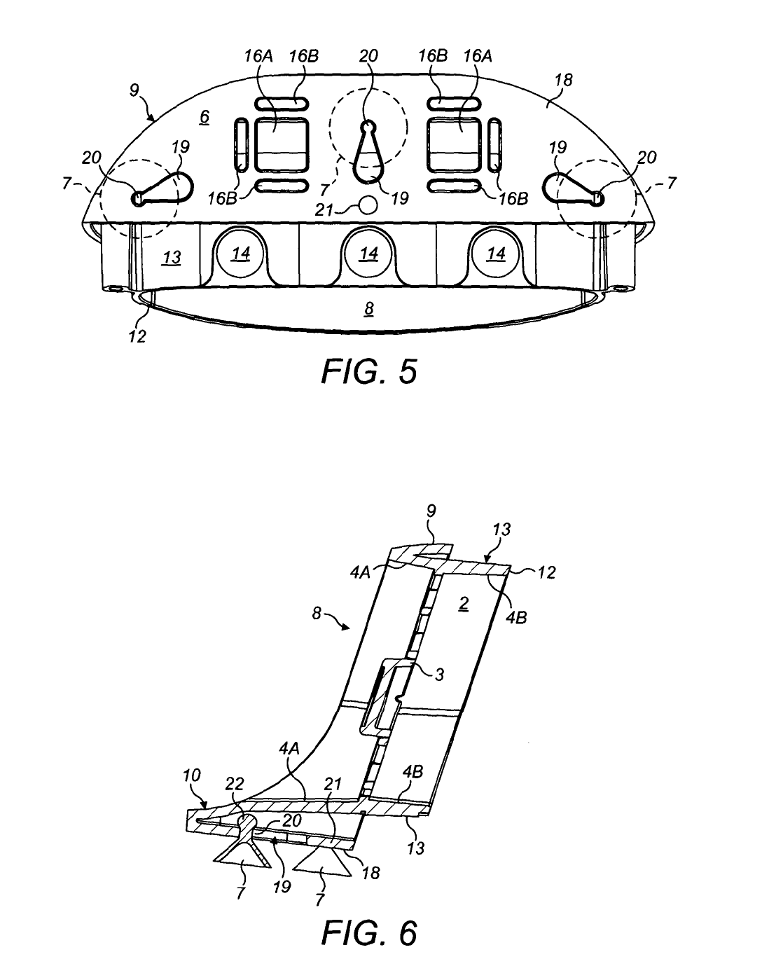

FIG. 5 illustrates a view of the base portion of the vent assembly of FIGS. 1 to 4;

FIG. 6 illustrates a sectional view in the section Z-Z indicated in FIG. 1;

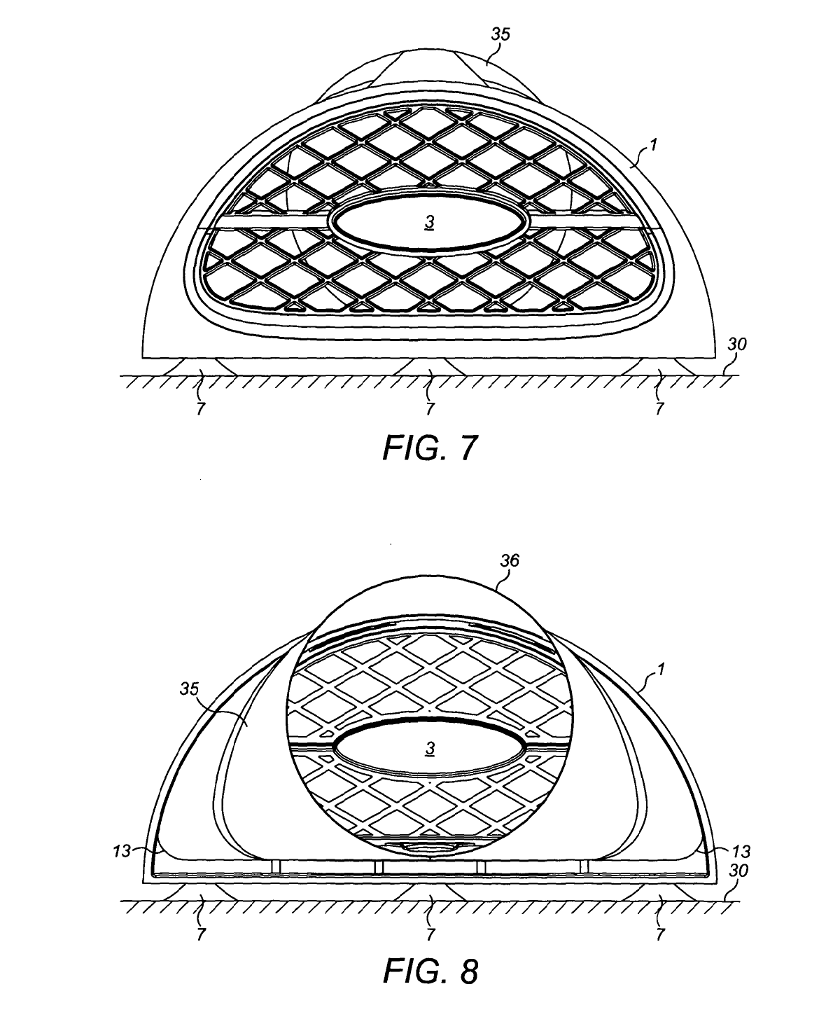

FIG. 7 illustrates a front view of a display apparatus attached to a vehicle surface and including the vent assembly of FIGS. 1 to 6 together with a display sleeve;

FIG. 8 illustrates a back view of the display apparatus of FIG. 7;

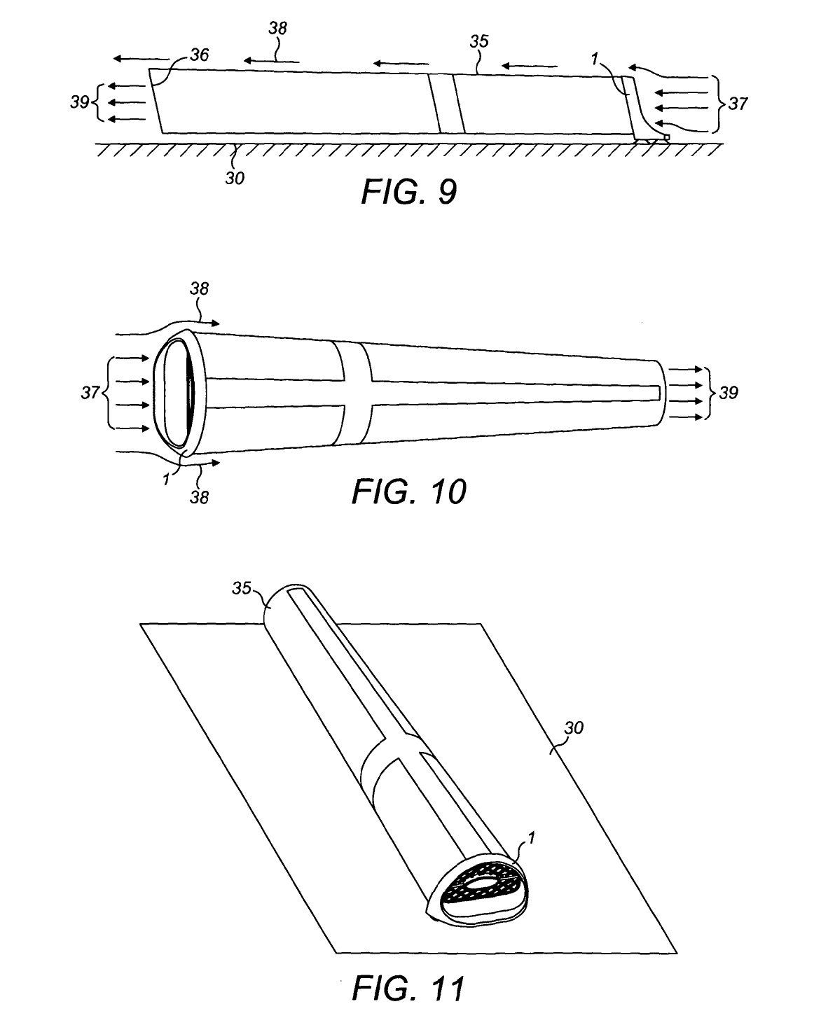

FIG. 9 illustrates a side view of the display apparatus of FIGS. 7 and 8;

FIG. 10 illustrates a top view of the display apparatus of FIGS. 7 to 9;

FIG. 11 illustrates a perspective view of the display apparatus of FIGS. 7 to 10;

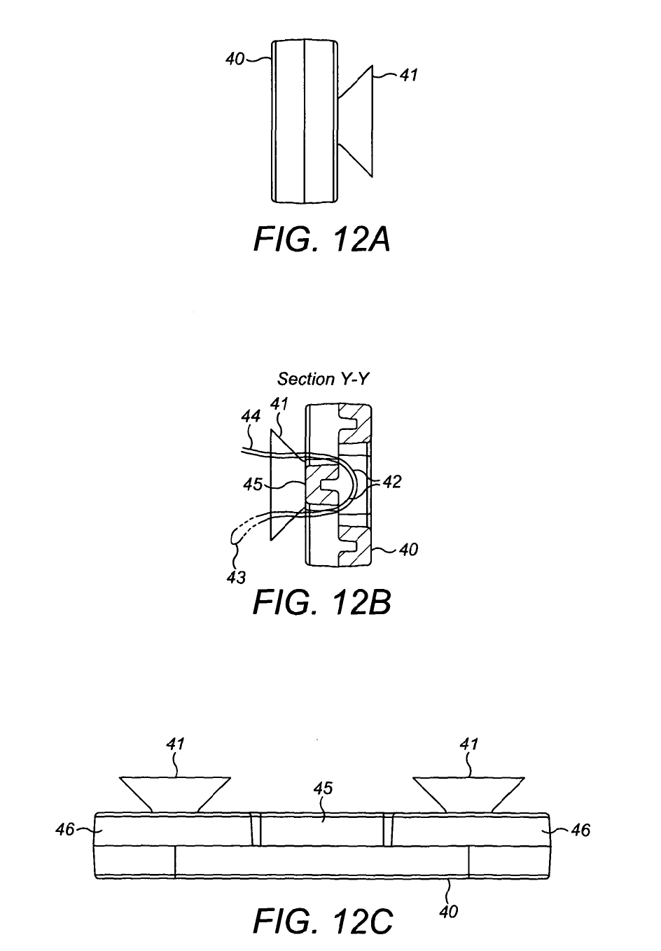

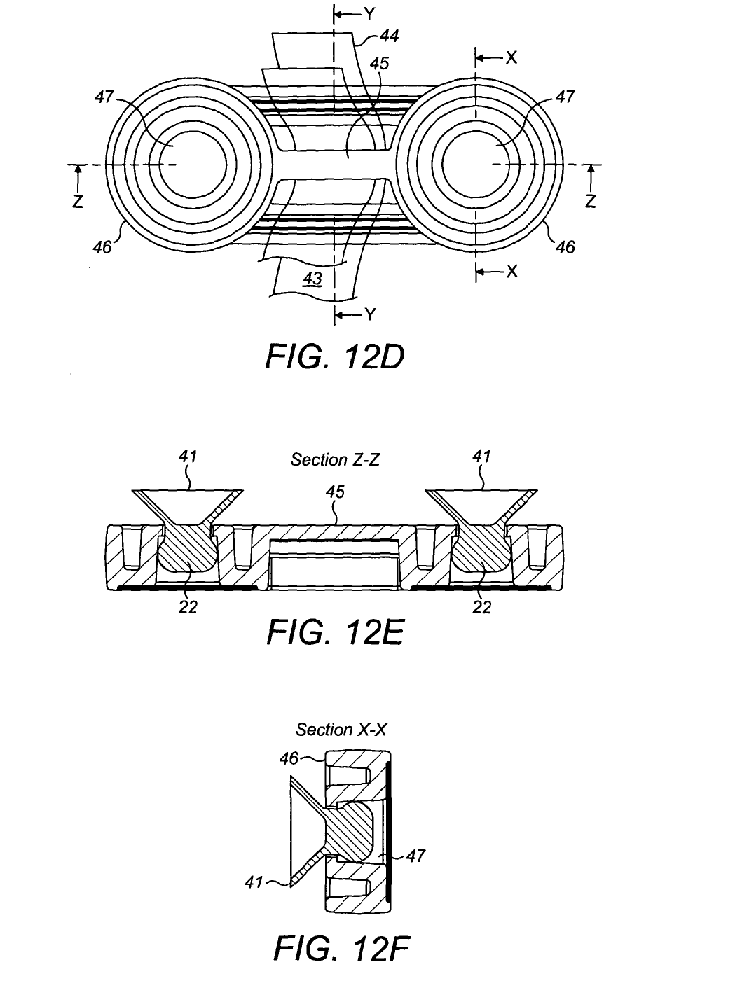

FIGS. 12A, 12B, 12C, 12D, 12E and 12F illustrate side, plan and cross sectional views of a retaining assembly for use with the display apparatus of FIGS. 1 to 11 for securing the display apparatus to a vehicle;

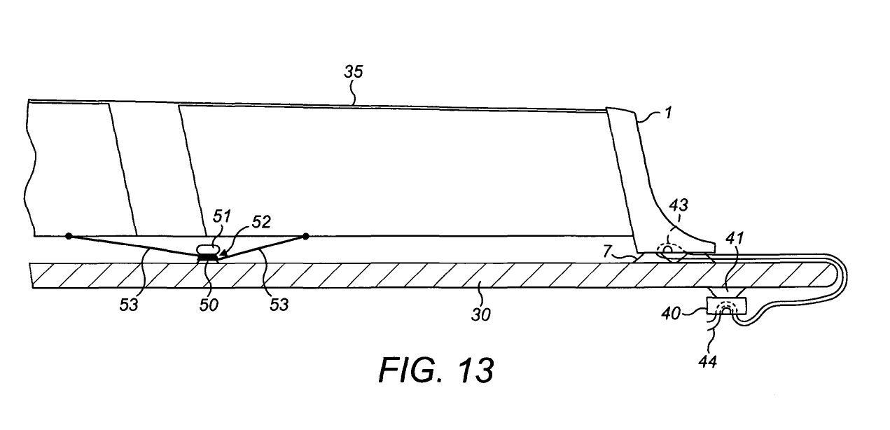

FIG. 13 illustrates a close-up side view of the display apparatus of FIGS. 7 to 11 attached to a vehicle surface and retained there upon using the retaining assembly of FIGS. 12A to 12F;

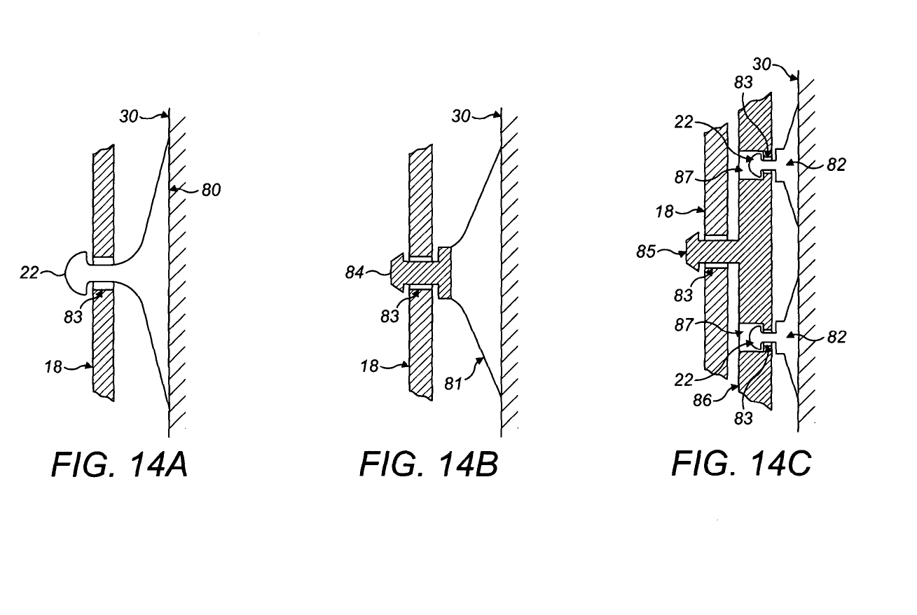

FIGS. 14A, 14B and 14C schematically illustrate in cross-section alternative attachment means via which a vent assembly and air intake mouth may be rotatably mounted (e.g. as in a turret upon an axle) to a vehicle surface;

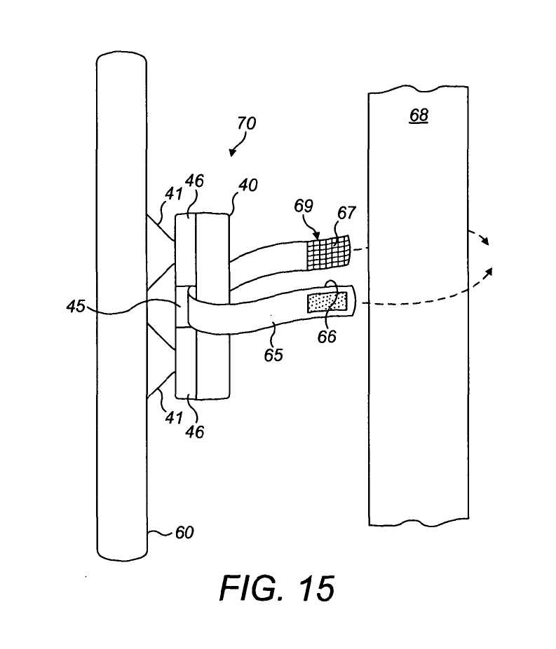

FIG. 15 illustrates an attachment apparatus.

Referring to FIG. 1 there is illustrated a front view of a vent assembly (1) of a display apparatus for displaying from a vehicle. The vent assembly includes a through opening (2) defining an air intake mouth (4) across which a highly perforated lattice-type grille (3) extends. The grille includes a centrally-disposed generally elliptical display panel for displaying an image, message, symbol or other information. A large plurality of diamond-shaped through-apertures are defined by a plurality of regularly spaced narrow grille bars. Air passing through the through-opening is thereby able to pass through the grille.

The vent assembly comprises a base portion (18) outwardly from which extend three suction cups (7) which are firmly attached to the base portion and are adapted to attach the grille assembly to a vehicle surface by suction such that the base portion of the vent is nearmost the local surface of the host vehicle. The base portion (18) presents a uniformly flat surface (6) from which substantially the only projecting elements are the suction cups (7). The vent assembly defines an archway (5) extending from the base portion (18) at one side of the vent, over the base portion and joining the base portion at the other side of the vent assembly. The archway (5) is integrally formed (as a moulding) with the base portion (18) of the vent assembly. The archway and base portion of the vent assembly define a generally elongate through-opening which presents an air intake mouth with a generally elongate gape. The gape of the air intake mouth is elongated in a direction across the base portion (18). The suction cups (7) are positioned upon the surface (6) of the base portion (18) to render the vent assembly attachable therewith to a vehicle surface in a position such that the elongated gape of the air intake mouth extends a greater distance across the surface of the vehicle then it extends away from the surface of the vehicle.

In particular, the base portion (18) of the vent assembly is generally flat and the archway formation (5) of the vent assembly is generally semi-circular thereby defining a D-shaped opening with the flat part of the D nearmost the suction cups (7) and, therefore, nearmost the vehicle surface when the vent assembly is attached to a vehicle.

Figure illustrates a plan view of the vent assembly of FIG. 1. The lip or rim (4) of the air intake mouth defined by the through-opening (2) juts forward and becomes broader at its lower-lip portions where it passes over the base portion (18) of the vent assembly. The lip is relatively narrower in its upper-lip portions where it follows the arch portion (5) of the vent assembly. This lower-lip portion (10) is generally inclined to form a wedge-shape at the base portion which expands from the leading edge of the vent assembly towards the through-opening. Air flowing towards the vent assembly and impinging upon the lower lip portion (10) is thereby displaced into the air intake mouth of the vent.

Outermost and forward-facing surface parts of the vent assembly are convexly curved with a common radius of curvature centred at a common curvature point to conform to a spherical surface curvature (9). Surface parts of the vent other than the lip portion (4) of the air intake mouth, such as at the arch portion, are generally curved in this way. This curvature provides an aero-foil function.

The air intake mouth extends from the mouth lip/rim region (4) into an air duct (8) defined by inner duct walls (4A, 4B) which taper to narrow the diameter of the duct at points progressively along the through-opening towards the air outlet end of the duct. This tapering, in conjunction with the wedge-shape of the lower lip portion of the air intake mouth (10), defines a ram-air intake which promotes increased air pressure within the air swept-up by the air intake mouth and output at the air outlet end (12) of the duct (8) defining the through-opening (2).

FIG. 6 illustrates these features in a cross-sectional view (Z-Z) viewed in the direction indicated in FIG. 1. Here, the aero-foil shape (9) of the arch portion of the vent assembly, the wedge nature of the lower mouth lip portion (10) and the tapering nature of the air inlet duct walls (4A) of the air intake mouth are evident.

Referring once more to FIG. 2, the outwardly-presented surface (13) of the rearward parts of the vent assembly defining the air outlet end (12) of the through-opening, matches the generally D-shape of the air intake mouth overall. This rearward surface is recessed relative to the forward-facing surface parts of the vent assembly (9, 10) and has fixed upon it, in regular circumferential array, a plurality of Velcro coins (14). Each Velcro® coin comprises a disc of Velcro® hook material adapted to cooperate with a corresponding portion of Velcro® loop material to be discussed further below. Recessed bays are formed in the outer rearward vent surface to receive the Velcro® coins. The thickness of the Velcro® coins is selected such that, when received in a recessed bay, the uppermost Velcro coin surface does not substantially project above or dip below the height of the walls of the recessed bay in question.

This rearward outermost vent surface (13) is adapted to receive, in an intimate fit, the inner surface parts of an air inlet opening of a sleeve portion (discussed below) to enable air collected by the air intake mouth to be directed into the sleeve portion by the duct (8) of the air intake mouth for the purpose of inflating the sleeve portion. Velcro® loop material attached to the inner surface of the air intake end of the sleeve portion may cooperate with the Velcro® hook material presented at the outwardly-facing surfaces of the Velcro® coins (14) arrayed along the rearward outer surface of the vent assembly thereby to attach the sleeve portion to the vent assembly.

FIGS. 3 and 4 illustrate side and rear views of the vent assembly in which like articles are assigned like reference numerals.

FIG. 5 illustrates an underside view of the vent assembly showing the base portion (18) of the vent, the circular curvature (9) of the forward-facing parts of the base portion, the air outlet end (12) of the duct (8) defining the through-opening of the air intake mouth, and recessed Velcro® coins (14) arrayed upon the outer surface of that air outlet end region as discussed above.

Formed within the outermost surface (6) of the base portion (18) are a number of openings (16, 19, 20, 21) adapted and arranged for attaching and securing the vent assembly to the vehicle in use. Suction cups (7) are shown in phantom using dashed lines in FIG. 5. This is done in order to permit a view of openings formed in the base surface which are adapted to cooperate with the suction cups.

In particular, three tapered slots (19) are formed in the outermost surface of the base portion and each is shaped and dimensioned to converge towards a terminal circular notch adapted and dimensioned to intimately receive the neck of a suction cup (see FIG. 6). Each suction cup comprises a flexible, hollow and open-based cone portion of well-known type which converges to an upper cone head (22) joined to the tip of the cone by a narrower neck portion. The dimensions of the wider end of each tapering slot (19) is such as to enable the slot to receive the head portion of suction cup whereas the circular notch part of the tapered slot (20) is dimensioned only to admit the neck portion of the suction cup but not the head portion. The neck diameter is less than the diameter of the head portion. In this way a suction cup can be attached to the base portion of the vent by slotting the neck of the suction cup into the circular notch at the narrow end of the tapered slot in a push-fit. In this position, the head portion of the suction cup prevents the suction cup being pulled out of the slot in a direction transverse to the slot.

Lanyard apertures (16A, 16B) are also formed in the outermost surface (6) of the base portion (18) of the vent assembly. Two groups of lanyard apertures are presented. Each group has the same arrangement of lanyard apertures and is intended to perform the same function. Each group of lanyard apertures comprises three elongate slot apertures (16B) each extending in parallel with and adjacent to a respective one of three of the four edges of a square aperture (16A) in close proximity thereto. The length of each slot aperture matches substantially the length of the square aperture to which it is adjacent. An elongate lanyard strap (43, 44 in FIG. 12D and FIG. 13) has a width and thickness which each of the lanyard apertures (16A, 16B) is dimensioned to accept. A terminal end of the lanyard strap may be threaded into a lanyard slot aperture (16B) and back out through an adjacent lanyard square aperture (16A) to permit the lanyard strap to attach to the vent assembly in a loop arrangement. The opposite terminal ends of the lanyard strap may then be secured elsewhere to the vehicle as described below to provide a means of retaining the vent assembly to the vehicle should the suction cups (7) fail.

A circular aperture (21) is formed in the lowermost surface (6) of the base portion of the vent for accepting a string, thread, cord or other line extending from (and connected to) the sleeve portion when attached to the vent assembly. This provides a lanyard for the sleeve assembly permitting the string, cord or thread passed through the circular aperture (21) to be tied securely to the vent assembly. This will retain the sleeve portion to the vent assembly should the Velcro coins (14) fail to do so.

FIG. 7 shows a front view of a display apparatus comprising the vent assembly illustrated in FIGS. 1 to 6 to which is attached a sleeve portion (35). The vent assembly is attached to a surface of a vehicle (30) using the three suction cups (7) described above. The sleeve assembly is illustrated in the fully inflated state.

FIG. 8 illustrates a rear view of the display apparatus illustrated in FIG. 7. The sleeve portion (35) tapers from a generally D-shaped air inlet end to a circular air outlet end (36) having a smaller size/area than that of the air inlet of the sleeve.

The generally semi-circular shape of the air inlet of the sleeve portion (35) has a radius which is approximately equal to the diameter of the circular air outlet opening (36) of the sleeve. The result is that, as can be seen in FIG. 9, a side view of the fully inflated sleeve shows a sleeve of generally uniform height whereas, in plan view as shown in FIG. 10, the lateral width of the sleeve tapers from its air inlet end to its air outlet end. This results in a constriction of air flow lines (37) input to the sleeve portion by the vent assembly (1) as the flow lines progress through the sleeve portion and are output (39) at the air outlet end of the sleeve. This has the effect of increasing air pressure within the sleeve and assisting the stable inflation of the sleeve while the vehicle is in motion.

FIG. 11 illustrates a perspective view of the inflated sleeve, and illustrates a marking formed upon the outermost surface of the sleeve intended for presentation by the inflated sleeve. In this instance, the marking is a cross formation, such as a cross of St. George intended to represent the national flag of England.

FIGS. 12A, 12B, 12C, 12D, 12E and 12F illustrate various views of parts of a retaining assembly also illustrated in use in FIG. 13. The retaining assembly comprises a looped lanyard strap (43, 44) which is attached to the base portion of the vent assembly (1) by having been threaded through the lanyard apertures (16A, 16B) described above. Terminal ends (44) of the lanyard strap are then pulled adjacent to one another and collectively threaded through a buckle formation (45) formed in an anchorage block (40) of the retaining assembly. The anchorage block (40) of the retaining assembly comprises a pair of suction cups via which the anchorage block may be affixed to a surface (e.g. internal surface) of the vehicle to which the vent assembly is attached. For example, if the vent assembly is attached to an external surface of a vehicle window, the lanyard strap (43, 44) may be passed from the outside of the vehicle to the inside of the vehicle via an edge of the window when closed, and the anchor block (40) attached to the internal surface of the window using the suction cups (41) it possess. Alternatively, the lanyard strap may be passed around the edge of a closed vehicle door, or around the edge of a closed vehicle sun roof if the vent assembly is attached to the exterior surface of the roof, and the anchor block (40) attached to the interior surface of the sun roof.

FIGS. 12A and 12C show end and side views (respectively) of the anchorage block including two suction cups (41) separated by a buckle formation (45). FIG. 12E illustrates a sectional view in the direction (Z-Z) indicating the manner in which the suction cups (41) are attached to the body of the anchorage block. The suction cups in question (41) are of the same type and structure as the suction cups (7) employed in the vent assembly. Cup heads (22) retain the suction cups in apertures (47) formed in the anchorage block either side of the buckle assembly and each aperture has a lip or rim at the aperture entrance defining a constructed entrance diameter which is greater than the diameter of the suction cup neck but less than the diameter of the suction cup head portion. In this way the suction cups are held by their neck portions to the body of the anchorage block. FIG. 12F shows a cross-sectional view along section X-X illustrating this arrangement in addition to the illustration provided by FIG. 12E.

The buckle portion (45) disposed in between the pair of suction cups (41) is illustrated in plan view in FIG. 12D. In this figure the suction cups are not shown for the purposes of permitting a clearer illustration. A cross-sectional view along the section Y-Y is illustrated in FIG. 12B.

The buckle portion comprises two parallel outermost bars separated by a longitudinal slot over the longitudinal length, and to one side, of which extends a generally parallel intermediate bar. Each of these three bars extends in parallel in a direction from one of the pair of suction cups (41) to the other of the pair. The width of the intermediate bar is less than the width of the slot over which it extends so as to provide gaps between the intermediate bar and each of the outer bars at either side of the intermediate bar. In this way, the three bars are dimensioned and arranged to define a labyrinth through which the terminal ends (44) of the lanyard strap (43) may be threaded. The offset (transversely) positioning of the intermediate bar relative to the two outermost bars of the buckle assembly is such that the nearmost edges of the three bars substantially lie on the same plane and cause the threaded lanyard strap to substantially reverse direction as it passes into the buckle assembly from the side bearing the intermediate bar, and back out through the buckle assembly at the same side. The edges of the bars of the buckle assembly and the labyrinth nature of the structure they define effectively “bites” the surface of the lanyard strap within the labyrinth to prevent the strap being pulled out of the buckle assembly by application of a force to the looped end of the lanyard at the vent assembly (1).

FIG. 13 illustrates a securing means (50, 51, 52, 53) for the sleeve portion (35) comprising a length of cord, string or other flexible line (53) having opposite ends firmly attached to the sleeve assembly at its underside near most the local vehicle surface in use. A suction cup (50) comprising a hollow cone portion with a neck portion at its apex and topped by an expanded head portion (51). The suction cup carries a ring (52) circumscribing its neck portion of the suction cup. The ring (52) has the line (53) threaded through it together with the neck portion of the suction cup (50). The diameter of the ring is sufficient to admit both the neck portion of the suction cup and the diameter or width of the line threaded through it (53) in a tight interference fit against the outer surface of the neck portion of the suction cup. The interference of it is such that the line (53) threaded through the ring (52) is held firmly by a friction interface against the suction cup (50) thereby to prevent the suction cup moving relative the line (53) and, consequently, securing the sleeve portion (35) to the surface of the vehicle (30) via the suction cup. Preferably the suction cup (50)—and indeed preferably every suction cup employed in the display apparatus (7, 41 etc)—may be formed of a resiliently deformable material which permits the head portion of the suction cup to be manually forced into or out of the ring (52) to permit the ring to be moved along the line (53) to which it is threaded to a new position at which it may be secured by reinserting the head portion of the suction cup into the newly re-positioned ring. The ring may be rigid or deformable.

FIGS. 14A, 14B and 14C schematically illustrate in cross-section a part of the apparatus showing the base of the vent (vent not shown in full) and its attachment means. Several alternative attachment means are shown via which the vent assembly (1) and air intake mouth (4) may be rotatably mounted (e.g. as in a turret upon an axle) to a vehicle surface (30) at the base portion (18, 86) of the vent assembly. The attachment means may comprise one or more suction cups (80, 81, 82) adapted to be securely positioned upon the vehicle surface (30). When only one suction cup is employed (FIGS. 14A, 14B), the base portion (18) is arranged to be rotatable about an axis defined by the neck portion of that suction cup which extends generally transversely to (e.g. in a direction generally perpendicular to) the vehicle surface to which the suction cup is adapted to attach, and the base portion to which the suction cup is attached via its neck portion. Alternatively, the attachment means (or the base portion) may comprise a mounting plate (86) rotatingly connected to the vent portion via a spigot (85).

These arrangements permit the vent portion, and the air intake mouth within it (not shown in FIGS. 14A, 14B, 14C), to rotate about the axis of the suction cup neck (or spigot) when attached to the vehicle and so permit the air intake mouth to adopt a stable, optimal orientation when subjected to air flow over the vehicle in motion. This permits the vent to move to maximise air intake rates and permit a reduction of net forces upon the assembly in use transverse to the direction of air flow which may urge the vent portion to separate from the vehicle.

In a first example (FIG. 14A) this pivoting arrangement is achieved by employing a single suction cup (80) to attach the vent assembly to the vehicle surface. The conical body of the single suction cup converges to a neck portion which terminates at a resiliently deformable upper cone head (22) which is wider than the neck portion where in joins the neck portion to define an obstruction flange extending transversely from the sides of the neck portion at that end. The base portion of the vent assembly has formed within it a through-opening (83) adapted to receive the diameter of the neck portion of the cup but to prevent passage therethrough of the upper cone head at one side of the through-opening and the conical body of the suction cup at the other side of the through-opening. The resilient deformability of the cone head permits it to be squeezed through the through-opening during assembly, whereas the obstruction flange obstructs removal of the cone head through the through-opening. Thus, the suction cup is mounted captive upon the base portion. The through-opening (83) is wider than the received diameter of the neck portion by an amount sufficient to permit the base portion (18) to freely rotate around the neck portion at the through-opening.

In a second example (FIG. 14B), the neck portion and upper cone head (84) of the single suction cup (81) are formed from a rigid material (e.g. plastic) to which the resiliently deformable cup end (81) of the suction cup is fixed (e.g. glued, welded, fitted etc). The rigid neck portion provides the bearing surface about which the base portion (18) is rotatable at the through-opening (83). The upper cone head (84) may be snap-fitted through the through-opening.

In a third example, the attachment means (or the base portion) comprises a mounting plate (86) to which a plurality of suction cups (two shown) are mounted at one common side of the mounting plate. A reverse side of the mounting plate presents a single spigot (85) upon which the vent portion (18) is mounted in a snap-fit. A neck portion of the spigot is rotatably received within the through-opening (83) presented at the vent portion (18). The neck portion terminates at a head end located at a side of the through-opening opposite to the side at which the main body of the mounting plate is located. The head end has a diameter greater than that of the through-opening thereby holding the mounting plate captive upon the base portion. The conical body of each of the plurality of suction cups (82) converges to a neck portion which terminates at a resiliently deformable upper cone head (22) which is wider than the neck portion where it joins the neck portion to define an obstruction flange extending transversely from the sides of the neck portion at that end. The mounting plate (86) has formed within it plurality of through-openings (83) adapted to receive the diameter of the neck portion of a respective cup but prevent passage therethrough of the upper cone head at one side of the through-opening and the conical body of the suction cup at the other side of the through-opening. Each through-opening in the mounting plate expands in diameter sufficient to receive and house the upper cone head of the respective suction cup such that the cone head does not extend from the mounting plate to obstruct rotation of the vent assembly (18) about the spigot (85). In alternative embodiments, the spigot (85) may instead be formed in and extend from the lower most surface of the vent portion (18) to be received in a through-opening (not shown) formed instead in the mounting pate such that the vent assembly may rotate relative to the mounting plate via its spigot.

FIG. 15 illustrates an attachment apparatus (70) for detachably attaching a mobile phone (60) to a bike or car part (68—e.g. a handle bar). The apparatus includes a body portion (40) having the same structures as the anchorage block illustrated and described with reference to FIGS. 12A to 12F. The body portion includes two suction cups presented outwardly of the body portion and adapted and arranged to detachably attach the body portion to a surface of the mobile phone as indicated, by suction. A flexible connector strap (65) is threaded through the buckle formation (45) of the body portion with two free terminal ends (66,67) available for passing around the bike or car part in opposite respective senses (as indicated by dashed arrows in FIG. 14) and for then connecting together to form a closed loop which embraces the bike or car part and thereby attaches the body portion to the bike/car part.

The two free ends of the tie each comprise one of two Velcro® pads (69) for releasibly engaging with the corresponding other of the two pads for connection together to close the strap into a loop embracing the bike/car part in the manner of a watch strap.

It is to be understood that the examples given above are intended for the purposes of illustration and it is contemplated that modifications or variations of the examples described above, such as would be readily apparent to the skilled person, are encompassed within the scope of the invention as defined by claims.

1. A display apparatus for a vehicle including:
a vent portion comprising a through-opening defining an air intake mouth, and attachment means adapted to render the vent portion attachable therewith to a surface of the vehicle in a position intimately proximate thereto to permit the air-intake mouth to intake vehicle-displaced airflow at said surface of the vehicle;
a flexible sleeve portion defining an air duct extending from the through-opening to an air outlet opening of the sleeve portion being inflatable by action of a flow of air therethrough from the through-opening to display an outer surface of the inflated sleeve portion.

2. A display apparatus according to claim 1 in which a gape of the air intake mouth is elongated and the attachment means is adapted to render the vent portion attachable therewith to said surface of the vehicle in a position such that the gape of the air intake mouth extends a greater distance across said surface of the vehicle than it extends away from said surface of the vehicle.

3. A display apparatus according to claim 1 in which the through-opening is shaped to define an air flow direction therethrough and the air intake mouth presents an elongated gape in said air flow direction.

4. A display apparatus according to claim 1 in which the through-opening defines an air duct extending from a perimeter lip of the air intake mouth to an air outlet throat in fluid communication with the flexible sleeve.

5. A display apparatus according to claim 1 in which the through-opening narrows form its air inlet end to its air-outlet end to define a ram-air intake.

6. A display apparatus according to claim 1 in which the vent portion includes a base portion comprising a vehicle interface region being the region of the vent portion which the attachment means is adapted to position nearmost the vehicle surface, and an air deflection surface portion shaped for deflecting air in a direction away from the vehicle interface region and in to the air intake mouth.

7. A display apparatus according to claim 1 in which the vent portion includes a base portion comprising a vehicle interface region being the region of the vent portion which the attachment means is adapted to position nearmost the vehicle surface, and an arch portion extending over the base portion and joined thereto at opposite arch ends thereby defining the through-opening.

8. A display apparatus according to claim 7 in which arch portion presents a surface facing away from the through-opening which is shaped for deflecting air in a direction away from the air intake mouth.

9. A display apparatus according to claim 1 in which the vent portion is rigid or resilient.

10. A display apparatus according to claim 1 in which the sleeve portion is sufficiently flexible to be collapsible when not inflated.

11. A display apparatus according to claim 1 in which the area of the air outlet opening is less than the area of the through-opening.

12. A display apparatus according to claim 1 in which the sleeve portion is detachably attachable to the vent portion.

13. A display apparatus according to claim 1 in which the sleeve portion comprises a sheet having two short edges separated by two long edges which are detachably attached together along their respective lengths to define a sleeve.

14. A display apparatus according to claim 1 including a securing part separate from the vent portion and adapted for secure attachment to a surface of the vehicle, and a flexible connection means connecting the securing part to the vent portion in the manner of a lanyard.

15. A kit of parts for a display apparatus according to claim 1 comprising two separable parts in which the vent portion is a first said part and the sleeve portion is a second said part.

16. A method of displaying a display from a vehicle including:
providing a vent portion comprising a through-opening defining an air intake mouth, and;
providing a flexible sleeve portion defining an air duct extending from the through-opening to an air outlet opening of the sleeve portion;
attaching the vent portion to a surface of the vehicle in a position intimately proximate thereto to permit the air-intake mouth to intake vehicle-displaced airflow at said surface of the vehicle;
inflating the sleeve portion by action of a flow of air therethrough from the through-opening to display an outer surface of the inflated sleeve portion.

17. A method according to claim 16 in which a gape of the air intake mouth is elongated and the method includes attaching the vent portion to said surface of the vehicle in a position such that the gape of the air intake mouth extends a greater distance across said surface of the vehicle than it extends away from said surface of the vehicle.

18. Attachment apparatus for detachably attaching an object to a structure comprising:
a body portion including suction parts presented outwardly of the body portion and adapted and arranged to detachably attach the body part to a surface of the object by suction;
a connector portion for connecting the body portion to the structure.

19. Attachment apparatus according to claim 18 in which the suction parts comprise one or more suction cups.

20. Attachment means according to claim 18 in which the connector portion comprises one or more flexible tie parts extending from the body portion and adapted to tie the body portion to the structure.

21. (canceled)

22. (canceled)
